(19) United States
(12) Patent Application Publication
(10) Pub. No.: US 2002/0135491 A1
(43) Pub. Date: Sep. 26, 2002

(54) Electronically controlled multi-tone peripheral

(75) Inventor: Paul H. Maier JR., Athol, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Simplex Time Recorder Co., Westminster, MA (US)

(21) Appl. No.: 09/815,247

(22) Filed: Mar. 22, 2001

(51) Int. Cl. G08B 25/08

(52) U.S. Cl. 340/692; 340/541; 340/540; 340/506

(57) ABSTRACT

An audible alarm is provided for use in an alarm system which produces a plurality of distinct audible alarm signals in response to a control signal. The audible alarm can further produce a prerecorded voice message which can be stored at the audible alarm. A microcontroller at the audible alarm controls the audible alarm in response to the control signal which can be received from a control panel over a pair of lines. The control panel further supplies power over the pair of lines.

### BACKGROUND OF THE INVENTION

Typical building fire alarm systems include a number of fire detectors positioned throughout a building. Signals from those detectors are monitored by a system controller, which, upon sensing an alarm condition, sounds audible and/or visual alarms, also referred to as notification appliances, throughout the building. In some situations, it is desirable to provide more than one audible tone or pattern from the same notification appliance, for example, a bell sound which could indicate a fire and a slow whoop sound which could indicate a tornado warning.

### SUMMARY OF THE INVENTION

One prior art system has achieved multiple tones at the audible alarm by providing an audio system, which typically includes a playback device and an amplifier, installed at a remote location such as a fire alarm control panel (FACP) with speakers positioned on or adjacent to the notification appliance. However, for small installations needing little notification, this is prohibitively expensive for the system and installation.

Another prior art system includes a hardwired alarm system installed with different types of notification appliances connected to different notification appliance circuits (NACs). However, this system requires additional notification circuits at the control panel, as well as multiple notification appliances, each having a different tone, at each intended installation point. This is also expensive and carries the additional burden of extra wiring and a less aesthetic installation as multiple notification devices grouped together on a wall can be unsightly.

In accordance with the present invention, an audible alarm is provided for use in an alarm system which produces a plurality of distinct audible alarm signals in response to a control signal. The alarm signals can include distinct audible tones and audible patterns. The audible alarm can further produce a prerecorded voice message which can be stored at the audible alarm.

In one embodiment, a microcontroller at the audible alarm controls the audible alarm in response to the control signal which can be received from a control panel over a pair of lines. The control panel can further supply power over the pair of lines. The audible alarm can further include a communications receiver that receives and interprets the control signal.

In accordance with another aspect, an alarm system is provided which includes at least one audible alarm, and a system controller coupled to the audible alarm by a pair of lines. The system controller provides power over the pair of lines and sends a control signal over the pair of lines for directing the audible alarm to produce a plurality of distinct audible alarm signals.

A method of controlling an alarm system is also provided which includes providing an audible alarm coupled to a controller and controlling, with the controller, the audible alarm to produce a plurality of distinct audible alarm signals. The method can further include providing power to the audible alarm with the controller.

A method for controlling an audible alarm in an alarm system is further provided which includes dynamically changing, with encoded signals over a power line, audible tones or patterns of the audible alarm.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a fire alarm system in accordance with an embodiment of the present invention.

FIG. 2 is a block diagram of an exemplary notification appliance in accordance with the present invention.

### DETAILED DESCRIPTION OF THE INVENTION

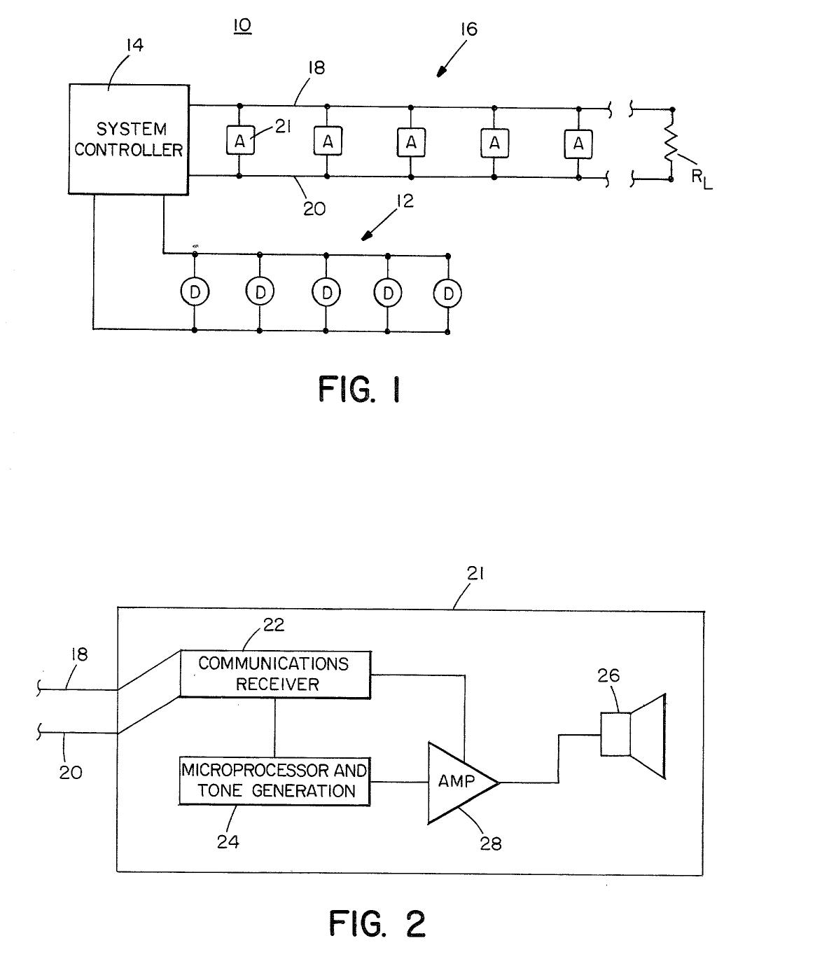

A description of preferred embodiments of the invention follows. An alarm system 10 constructed according to the principles of the present invention is illustrated in FIG. 1. As in a conventional alarm system, the system includes one or more detector networks 12 having individual alarm condition detectors D which are monitored by a system controller or control panel 14. When an alarm condition is sensed, the system controller 14 signals the alarm to the appropriate devices through at least one network 16 of addressable alarm notification appliances A. Each device, also called a notification appliance 21, may include one or more notification devices, for example, a visual alarm (strobe), an audible alarm (horn), or a combination thereof (A/V device).

As shown, all of the notification appliances are coupled across a pair of power lines 18 and 20 that advantageously also carry command messages from the system controller 14 to the notification appliances 21.

In a supervisory mode of operation, in one embodiment of the invention, a first polarity DC voltage is applied across the notification circuit 16. In this mode, rectifiers at the notification appliances are reverse biased so that the audible and visual alarms are not energized, but current flows through the power lines 18, 20 to an end-of-line resistor R_{L} and back, allowing the condition of those lines to be monitored.

With an alarm condition, also referred to as active mode, the polarity of the voltage applied across the power lines 18, 20 is reversed (or forward biased) to energize all notification appliances 21 on the notification circuit 16. In one embodiment of the present invention, the first polarity DC is −24 VDC and the forward biased voltage is 24 VDC, although other voltages can be used in accordance with the present invention.

The control panel 14 can control the notification appliances 21 and provide power over the power lines 18, 20 as described in copending U.S. application Ser. No. 09/438,560 filed Nov. 10, 1999, and Ser. No. 09/312,108 filed May 14, 1999, the contents of each being incorporated herein by reference. Thus, patterns in the power voltage, such as dropouts and spikes, can be sent from the control panel over the power lines to each notification appliance to control the audible output of the notification appliance 21.

As shown in FIG. 2, power lines 18 and 20 connect to the notification appliance 21, and specifically to a communications receiver 22. The communications receiver 22 is provided to interpret or decode the command messages received from the system controller 14. Communicating with the receiver 22 is microcontroller 24 which controls the visible alarm (not shown), such as a strobe, and the audible alarm 26. In one embodiment, the microprocessor 24 controls the audible alarm 26 to control at least two different audible signals, such as audible patterns or tones. The microprocessor 24 can also have prerecorded messages stored therein which are broadcast by the audible alarm 26. Thus, the microprocessor 24 can be referred to as an alarm generator. An amplifier 28 is provided to boost the output of the microprocessor 24 and receiver 22 to the alarm 26. Audible alarm 26 can include any transducer or enunciator device such as a bell, chime, horn, or whistle.

In alternative embodiments, a single alarm generator can be coupled to multiple audible alarms, such as alarm 26. The alarm generator can select, in response to a control signal, which audible alarm to generate an audible signal.

While this invention has been particularly shown and described with references to preferred embodiments thereof, it will be understood by those skilled in the art that various changes in form and details may be made therein without departing from the scope of the invention encompassed by the appended claims.

What is claimed is:

1. An audible alarm for use in an alarm system, the audible alarm producing a plurality of distinct audible alarm signals in response to a control signal.

2. The audible alarm of claim 1, wherein the audible alarm produces a prerecorded voice message.

3. The audible alarm of claim 1, wherein the prerecorded voice message is stored at the audible alarm.

4. The audible alarm of claim 1, further comprising a microcontroller at the audible alarm that controls the audible alarm.

5. The audible alarm of claim 1, wherein the microcontroller receives the control signal from a control panel over a pair of lines.

6. The audible alarm of claim 5, wherein the control panel further supplies power to the audible alarm over the pair of lines.

7. The audible alarm of claim 5, wherein the audible alarm includes a communications receiver that receives and interprets the control signal.

8. The audible alarm of claim 1, wherein at least one of the alarm signals includes a plurality of distinct tones.

9. The audible alarm of claim 1, wherein at least one of the alarm signals includes a plurality of distinct audible patterns.

10. An audible alarm for use in an alarm system that produces a plurality of distinct audible alarm signals, the audible alarm being controlled by a control signal sent over a notification application circuit.

11. The audible alarm of claim 10, wherein power is also supplied over the notification circuit.

12. The audible alarm of claim 10, wherein the audible alarm produces a prerecorded voice message.

13. The audible alarm of claim 10, wherein the prerecorded voice message is stored at the audible alarm.

14. The audible alarm of claim 10, further comprising a microcontroller at the audible alarm that controls the audible alarm.

15. The audible alarm of claim 14, wherein the microcontroller receives the control signal over the notification appliance from a control panel.

16. An audible alarm for use in an alarm system, comprising:
an alarm generator to generate a plurality of distinct, audible alarm signals; and
control of the alarm generator responsive to a control signal applied to the audible alarm.

17. The audible alarm of claim 16, wherein the audible alarm produces a prerecorded voice message.

18. The audible alarm of claim 16, wherein the alarm generator receives the control signal from a control panel over a pair of lines which also supply power to the audible alarm over the pair of lines.

19. An alarm system comprising:
at least one audible alarm to generate plural distinct audible alarm signals; and
a system controller coupled to the audible alarm by a pair of lines, the system controller providing power over the pair of lines and sending a control signal over the pair of lines for directing the audible alarm to produce the plural distinct audible alarm signals.

20. The audible alarm of claim 19, further comprising a microcontroller at the audible alarm that controls the audible alarm in response to the control signal.

21. The audible alarm of claim 19, wherein the audible alarm produces a prerecorded voice message.

22. A method of controlling an alarm system, comprising:
providing an audible alarm coupled to a controller; and
controlling, with the controller, the audible alarm to produce a plurality of distinct audible alarm signals.

23. The method of claim 22, further comprising the step of providing power to the audible alarm with the controller.

24. The method of claim 22, further comprising the step of producing, with the audible alarm, a prerecorded voice message.

25. A method for controlling an audible alarm in an alarm system comprising dynamically changing, with encoded signals over a power line, audible tones or patterns of the audible alarm.
